(19) United States
(12) Patent Application Publication
(10) Pub. No.: US 2013/0004043 A1
(43) Pub. Date: Jan. 3, 2013

(54) Pixel and Voxel-Based Analysis of Registered Medical Images for Assessing Bone Integrity

(75) Inventors: Brian D. Ross, Ann Arbor, MI (US); Craig Galban, Ann Arbor, MI (US)

(73) Assignee: THE REGENTS OF THE UNIVERSITY OF MICHIGAN, Ann Arbor, MI (US)

(21) Appl. No.: 13/539,232

(22) Filed: Jun. 29, 2012

Related U.S. Application Data
(60) Provisional application No. 61/503,824, filed on Jul. 1, 2011.
(60) Provisional application No. 61/559,498, filed on Nov. 14, 2011.

(51) Int. Cl. G06K 9/00

(52) U.S. Cl. 382/131; 382/128

(57) ABSTRACT

The present disclosure is directed to methods, systems, and products for analyzing a sample tissue region of a body to determine the state of the tissue. The methods, systems, and products include collecting one or more images via a medical imaging device, where the one or more images are taken at different time intervals. The images are registered and further processed to form a phenotype classification map that may be used to assess the integrity of bone over time, where the assessment can include a global and a regional assessment of bone integrity.

### CROSS-REFERENCE TO RELATED APPLICATIONS

This application claims priority to U.S. Provisional Application No. 61/559,498, entitled “Tissue Phenotype Classification Mapping System and Method,” filed Nov. 14, 2011, and U.S. Provisional Application No. 61/503,824, entitled “Pixel and Voxel-Based Analysis of Registered Medical Images for Assessing Bone Integrity,” filed Jul. 1, 2011, both of which are incorporated herein in their entirety.

### FIELD OF THE INVENTION

The present disclosure relates to novel and advantageous systems and methods for monitoring tissue regions and, more particularly, to systems and methods for detecting changes in tissue regions over a period of time, for example, during patient diagnosis or treatment.

### BACKGROUND OF THE INVENTION

Bone remodeling may be required as a consequence of primary bone cancer, metastases to the bone, bone resorption prevention treatment, osteoporosis as a result of hormone therapy, chemotherapeutic and radiation treatment of cancer, menopause therapy, or other diseases, states, or accidents, for example. The effectiveness of an intervention to treat bone is traditionally determined by taking one or more images or scans and calculating the mean value of all pixels within a volume of interest (VOI), and then calculating the difference in the mean values pre- and post-intervention or simply over time to monitor bone composition. These techniques, however, provide no information about regional variation and/or response to treatment. There is thus a need for imaging techniques that provide both global and regional information about the change in tissue over time.

### BRIEF SUMMARY OF THE INVENTION

The present disclosure in one embodiment is directed to a method of analyzing a sample region of a body to determine the state of the tissue. The method includes collecting, using a medical imaging device, a first image data set of the sample region at a first time point, the first image data set comprising a first plurality of voxels each characterized by a signal value in the first image data set. Further, the method includes collecting, using the medical imaging device, a second image data set of the sample region while at a second time point, the second image data set comprising a second plurality of voxels each characterized by a signal value in the second image data set. After the images are collected, the method includes registering, in an image processing module, the first image data set to produce a spatially transformed third image data set comprising a plurality of voxels, such that the third image data set includes the first image data set and the second image data set registered to share the same geometric space, and wherein each of the plurality of voxels comprising the third data set includes information derived from corresponding voxels in both the first and second image data set. Next, the method includes determining, in the image processing module, changes in signal values for each of the third plurality of voxels in the third image data set, wherein the change is the change in signal values between corresponding voxels in both the first and second image data sets, which are both included in the third image data set. The method further includes forming, in a tissue state diagnostic module, a tissue classification map of mapping data including changes in signal values from the registered image data, wherein the mapping data includes the changes in signal values segmented by the first time point and the second time point. The method includes performing, in the tissue state diagnostic module, a threshold analysis of the mapping data to segment the mapping data into a plurality of regions, including at least one region indicating the presence of a first tissue state condition and at least one region indicating the non-presence of the first tissue state condition.

In another embodiment, the present disclosure is directed to a method of analyzing a sample region of bone tissue to assess bone integrity. The method includes collecting, using a medical imaging device, a first image data of the sample region at a first time point, the first image data comprising a first plurality of voxels each characterized by a signal value in the first image data; and collecting, using the medical imaging device, a second image data of the sample region at a second time point, the second image data comprising a second plurality of voxels each characterized by a signal value in the second image data. Next, the method includes performing a registration, in an image processing module, on the first image data and the second image data to produce a co-registered image data comprising a third plurality of voxels each corresponding to at least one of the first plurality of voxels and at least one of the second plurality of voxels; and determining changes in signal values for each of the third plurality of voxels for the co-registered image data between the first time point and the second time point. The method further includes forming bone integrity classification mapping data of the changes in signal values from the co-registered image data, wherein the mapping data includes the changes in signal values segmented by the first time point and the second time point. The method next includes performing a threshold analysis of the mapping data to segment the mapping data into at least one region indicating the presence of mineralized bone tissue, and at least one region indicating the reduction of mineralized bone tissue.

In another embodiment of the present disclosure, the invention is directed to an apparatus having a processor and a computer-readable medium that includes instructions that when executed by the processor cause the apparatus to collect, from a medical imaging device, a first image data of a sample region of bone tissue at a first time point, the first image data comprising a first plurality of voxels each characterized by a signal value in the first image data; and to collect, from the medical imaging device, a second image data of the sample region of bone tissue at a second time point, the second image data comprising a second plurality of voxels each characterized by a signal value in the second image data; perform registration of the first and second image data, in an image processing module of the apparatus, to produce a co-registered image data comprising a third plurality of voxels each corresponding to at least one of the first plurality of voxels and at least one of the second plurality of voxels; determine, in the image processing module, changes in signal values for each of the third plurality of voxels for the co-registered image data between the first time point and the second time point; form, in a pathology diagnostic module of the apparatus, tissue state classification mapping data of the changes in signal values from the co-registered image data, wherein the mapping data includes the changes in signal values segmented by the first time point and the second time point; perform, in the pathology diagnostic module, a threshold analysis of the mapping data to segment the mapping data into a plurality of regions, including at least one region indicating the presence of a first tissue condition and at least one region indicating the non-presence of the first tissue condition.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

This patent or application file contains at least one drawing executed in color. Copies of this patent or patent application publication with color drawing(s) will be provided by the United States Patent and Trademark Office upon request and payment of the necessary fee.

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 illustrates an example implementation of the PCM method applied to CT image data scans of osseous tissue, in accordance with one embodiment of the present disclosure.

FIG. 2 illustrates PCM displays and scatter plots resulting from a single slice through the tibia of mice with bone metastases treated with ZA or the vehicle.

FIG. 3 illustrates bar plots of the summary results for an example implementation of the PCM technique as illustrated in FIGS. 1 and 2.

FIG. 4 illustrates representative images and scatter plots of a slice through the tibia from an ovariectomized animal, taken at different times.

FIG. 5 is bar plots of the summary results for the example implementation of the PCM technique as illustrated in FIG. 4.

FIG. 6 illustrates the use of the PCM methodology for analyzing 2-dimensional X-Ray bone scans, according to an embodiment of the present disclosure.

FIG. 7 provides of ex vivo images of proximal tibia four weeks post-surgery.

FIG. 8 illustrates plots showing relative change in bone volume fraction and bone mineral density over the study time period.

FIG. 9 illustrates representative PCM images and scatter plots from an OVX animal and a sham animal displayed as an axial slice over time (from left to right: weeks zero to four, respectively).

FIG. 10 illustrates bar plots showing the volume fraction of increased and decreased bone mineral from PCM analysis, in accordance with embodiments of the present disclosure.

FIG. 11 is a block diagram of an example of a computer system on which a portion of a system for diagnosing voxel-based changes within tissues may operate in accordance with the described embodiments.

### DETAILED DESCRIPTION

Generally, the present disclosure in some embodiments describes techniques for assessing a variety of tissues using a phenotype classification map (PCM) analysis of quantitative medical image data. The techniques use registration of image data, comparing images taken at different times and/or at different tissue states, from which a voxel-by-voxel, or pixel-by-pixel, image analysis is performed. The medical imaging data may be from a variety of different sources, including, but not limited to magnetic resonance imaging (MRI), computed tomography (CT), two-dimensional planar X-Ray, positron emission tomography (PET), dual-energy x-ray absorptiometry (DEXA), X-Ray (2D planar images), and single-photon emission computed tomography (SPECT), for example. Within a given instrumentation source (i.e. MRI, CT, X-Ray, PET, DEXA and SPECT, X-Ray (2D planar images) etc.) a variety of data can be generated. For example, MRI devices can generate diffusion, perfusion, permeability, and qualitative images in addition to hyperpolarized Helium and Xenon MRI, which can also be used to generate kinetic parameter maps. PET, SPECT and CT devices are also capable of generating kinetic parameters by fitting temporally resolved imaging data to a pharmacokinetic model. Imaging data, irrespective of source and modality, can be presented as quantified (i.e., has physical units) or normalized (i.e., images are normalized to an external phantom or something of known and constant property or a defined signal within the image volume) maps so that images can be compared between patients as well as data acquired during different scanning sessions.

PCM may be considered a specific application of a method called parametric response mapping (PRM), which was developed and shown to improve the sensitivity of diffusion-MRI data to aid in identifying early therapeutic response in glioma patients. PRM, when applied to diffusion-MRI data, had been validated as an early surrogate imaging biomarker for gliomas, head and neck cancer, breast cancer and metastatic prostate cancer to the bone, for example. In addition, PRM has been applied to temporal perfusion-MRI for assessing early therapeutic response and survival in brain cancer patients. PRM has been found to improve the sensitivity of the diffusion and perfusion MRI data by classifying voxels based on the extent of change in the quantitative values over time. This approach provides not only spatial information and regional response in the cancer to treatment but is also a global measure that can be used as a decision making tool for the treatment management of cancer patient. The global measure is presented as the relative volume of tumor whose quantitative values have increased, decreased or remained unchanged with time. As previously stated, as used herein, PCM may be considered a particular application of PRM. Throughout this application, the technique of the present disclosure may be referred to as including either PRM or PCM.

The techniques of the present disclosure are not limited to a particular type or kind of tissue region. By way of example only, suitable tissue types include lung, prostate, breast, colon, rectum, bladder, ovaries, skin, liver, spine, bone, pancreas, cervix, lymph, thyroid, spleen, adrenal gland, salivary gland, sebaceous gland, testis, thymus gland, penis, uterus, trachea, heart, brain, etc. In some embodiments, the tissue region is a whole body or large portion (e.g., a body segment such as a torso or limb; a body system such as the gastrointestinal system, endocrine system, etc.; or a whole organ comprising multiple tumors, such as whole liver) of a living human being. In some embodiments, the tissue region is a diseased tissue region. In some embodiments, the tissue region is an organ. In some embodiments, the tissue region is a tumor (e.g., a malignant tumor, a benign tumor). In some embodiments, the tissue region is a breast tumor, a liver tumor, a bone lesion, and/or a head/neck tumor.

The techniques are not limited to a particular type or kind of treatment. In some embodiments, the techniques are used as part of a pharmaceutical treatment, a vaccine treatment, a chemotherapy based treatment, a radiation based treatment, a surgical treatment, and/or a homeopathic treatment and/or a combination of treatments.

The present application describes techniques for assessing a variety of human tissues for a variety of purposes using a phenotype classification map (PCM) analysis of quantitative medical image data. The techniques use linear or warping algorithms to digitally register image data, comparing images taken at different times and/or at different tissue states and/or phases of movement and/or physiological states, from which a voxel-by-voxel, or pixel-by-pixel, image analysis is performed. The quantitative medical imaging data may be from a variety of different sources, including, but not limited to magnetic resonance imaging (MRI), computed tomography (CT), two-dimensional planar X-Ray, positron emission tomography (PET), dual-energy x-ray absorptiometry (DEXA), and single-photon emission computed tomography (SPECT), for example. The quantitative or semi-quantitative data metrics used for PCM analysis, generally does not include diffusion-sensitive MRI metrics, perfusion-sensitive MRI, CT, PET or SPECT imaging metrics and includes all other metrics, including for example, but not limited to, spin-lattice relaxation time (T1), spin-spin relaxation time (T2), T2*, T1rho, magnetization transfer constants, temperature, pH, oxygen tension, metabolic concentrations, iron content, fat content, conductivity, standardized uptake value (SUV), differential (or dose) uptake ratio (DUR), standardized uptake ratio (SUR) exchange rate constants, maximum uptake values, Hounsfield Unit (HU) values and normalized values. In some examples, the processing of image data, including either or both of registration and analysis, is performed automatically by the system, in other embodiments, some portion of the processing of image data may be done manually, while other portions may be done automatically by the system.

Generally, in some embodiments described herein the PCM technique of the present disclosure may classify image voxels into three (or in some cases more or less) distinct groups based on the difference in voxel HU values. By way of background, the Hounsfield unit (HU) scale is a linear transformation of the original linear attenuation coefficient measurement into one in which the radiodensity of distilled water at standard pressure and temperature (STP) is defined as zero Hounsfield units (HU), while the radiodensity of air at STP is defined as −1000 HU. In a voxel with average linear attenuation coefficient μₓ, the corresponding HU value is therefore given by: HU=1000×(μₓ−μ_{water}/μ_{water}), where μ_{water} is the linear attenuation coefficients of water. Thus, a change of one Hounsfield unit represents a change of 0.1% of the attenuation coefficient of water because the attenuation coefficient of air is nearly zero. The extent of the differences in voxel HU values relative to user-defined thresholds determines the classification of the individual voxels. Different classes of voxels may be represented on the PCM as different colors, in some embodiments. In some embodiments, now only is the difference in voxels based on HU values important, but in some cases the baseline or initial value from the first image may also convey useful information.

In some embodiments, the present application describes a voxel-by-voxel, or pixel-by-pixel, PCM image analysis technique that is capable of identifying regional bone integrity using quantitative medical imaging data, such as MRI, CT, X-Ray, PET, DEXA and SPECT (referred to as IMAGE throughout this document) capable of identifying regional bone integrity. The technique may be used in conjunction with bone remodeling that may be required as a result of bisphosphonate treatment, hormone therapy, metastases to the bone, osteoporosis, or chemotherapeutic and radiation treatment of cancer and menopause therapy, for example.

Generally, in some embodiments, the present disclosure includes systems, methods, and products for collecting bone image data serially, and registering the two or more temporally distinct data sets resulting from the image data using rigid (translate/rotate/scale) registration methods. In other embodiments, the registration process may employ warping registration techniques. Analysis of the image data sets may be accomplished by performing a voxel-wise comparison of the co-registered images. Once registered, changes in IMAGE values on a voxel-by-voxel scale can be quantified by a predetermined threshold into categories such as for example, those voxels that have undergone a significant increase, decrease or were unchanged from baseline. The techniques of the present disclosure may be used with and have been verified with regard to osteoarthritis and metastatic breast cancer to the bone. These techniques may also be used for analysis (used broadly to include, diagnosis, prognosis, assessment of treatment, etc.) of rheumatoid arthritis, multiple myeloma, and other diseases and conditions affecting bone. In some embodiments, a pixel-based image analysis technique is provided, which not only provides for volume fraction quantification of changes but also provides spatial information about bone integrity, which may be altered due to such causes as disease, treatment of a disease, age, and other factors, for example. This can be applied on 2-dimensional image data sets, projection images, as well as multi-slice 3-dimensional image data.

In addition to providing anatomical PCM maps, registration and image processing in some embodiments may also allow for individual voxels from the serial scans to be plotted as a scatter plot on a Cartesian coordinate where the axes correspond to two different time points, or two different imaging modalities, for example. In ome embodiment, for example, time point one may be plotted on the y-axis and time point two may be plotted on the x-axis, or in other embodiments, where individual voxels from a CT scan may be plotted on the x-axis, while individual voxels from an MRI may be plotted on the y-axis. It will be understood that any other suitable values may be plotted on the x- and y-axes, as desired. In some embodiments, each voxel can be classified based on their location within the coordinate system as healthy tissue or mineralized tissue, for example.

Whereas traditional techniques for assessing bone composition involve calculating the deviation of the mean value of all pixels within a region of interest (ROI) from a reference bone mineral density (BMD), referred to as the T or Z-scores, the current technique provides a pixel-based analysis, which not only provides volume fraction quantification of tissue that has undergone change, which can be used as a global measure of bone integrity, but also provides spatial information on the integrity of the bone that can be visualized on a planar or 3D bone density map. This spatial information is important, as it can serve as a biomarker that identifies compromised regional bone due to disease that may precede the onset of fractures and other orthopedic complications.

In one embodiment, the PCM technique is applied to CT image data scans of osseous tissue. The serial Hounsfield unit (HU) value of each voxel within both images is plotted as a function of the initial, i.e., time of diagnosis for example, HU value. Voxels in which the HU value in the sequential scan has increased (represented, for example on the PCM as red voxels) and decreased (blue voxels) significantly from baseline may be segmented from the rest of the bone (green voxels) to calculate the two PCM volumes: sum of red voxels (PCM(red)) and sum of blue voxels (PCM(blue)), respectively. Other cutoffs and thresholds can also be defined depending upon tissue and the particular needs associated with the condition of interest. PCM for monitoring changes in bone density can be used to assess disease progression and therapeutic response in bone, for example, but is not limited to osteoporosis and bone metastasis. While a particular color-coding scheme has been provided and is described herein, i.e. red voxels indicate an increase, blue voxels indicate a decrease, etc., it will be understood that any desirable or useful color-coding scheme may be employed with embodiments of the present disclosure. Further, other classification schemes are also contemplated, such as schemes that use a grey scale, or that use other symbols to distinguish differences between different tissue states on the PCM, for example different types of lines (dashed lines, straight lines, etc.), different shapes (circles, filled circles, open circles, squares, triangles, etc), or any other suitable coding scheme or combination of coding schemes may be used and are within the spirit and scope of the present disclosure.

In some embodiments, the PCM technique is a multiple step process for applying a PCM analysis of CT or other image data. The PCM system and techniques described and illustrated herein may be implemented in a special-purpose machine for image data analysis and tissue state characterization. In some cases the tissue state characterization may be employed for use in diagnosis, prognosis, determining response to treatment, or any other suitable purpose, or combination of purposes. The special-purpose machine may include at least one processor, a memory having stored thereon instructions that may be executed by that processor, an input device (such as a keyboard and mouse), and a display for depicting image data for the tissue under examination and identified characteristics (tissue states, etc.) of that tissue. Further, the machine may include a network interface to allow for wired/wireless communication of data to and from the machine, e.g., between the machine a separate machine or a separate storage medium, such as a separate imaging system and/or medical administrating device or system. The engines described herein, as well as blocks and operations described herein, may be executed in hardware, firmware, software, or any combination of hardware, firmware, and/or software. When implemented in software, the software may be stored in any computer readable memory within or accessed by the machine, such as on a magnetic disk, an optical disk, or other storage medium, in a RAM or ROM or flash memory of a computer, processor, hard disk drive, optical disk drive, tape drive, etc. Likewise, the software may be delivered to a user or a system via any known or desired delivery method including, for example, on a computer readable disk or other transportable computer storage mechanism or via communication media. When implemented in hardware, the hardware may comprise one or more of discrete components, an integrated circuit, an application-specific integrated circuit (ASIC), etc.

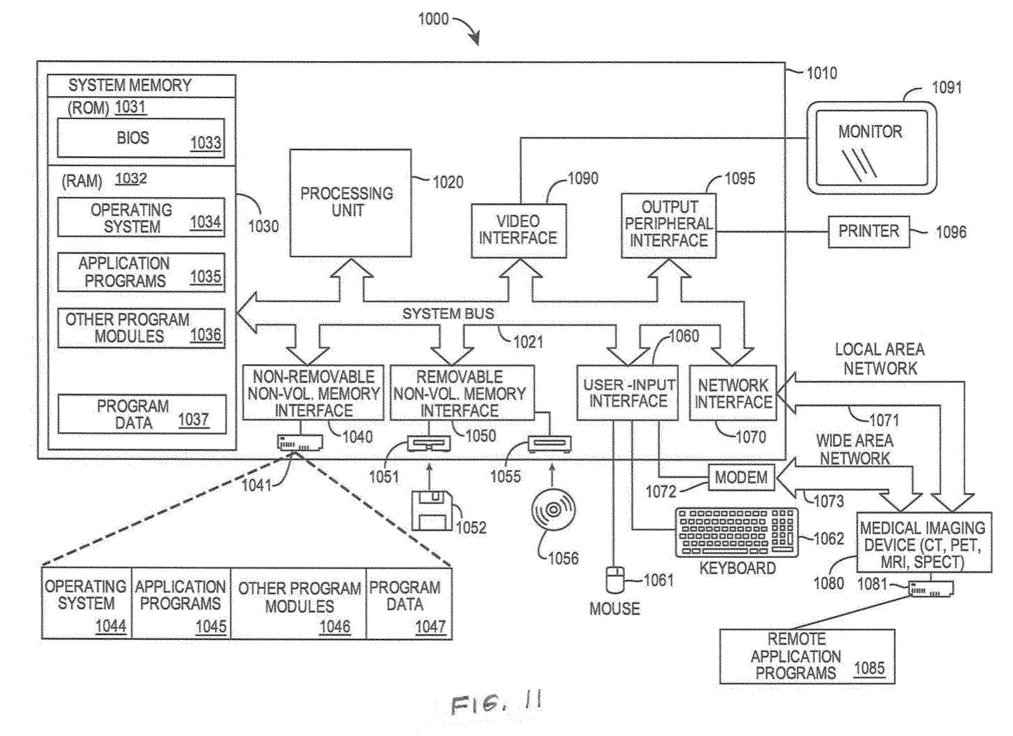

As applied to a CT based system, initially serial CT images may be collected at different times, for example. The image data may be collected from an external CT system in communication with a processor-based PCM system, e.g., connected through wired or wireless connections. In other examples, the PCM system may be embedded with a medical imaging system, e.g, a CT system, MRI system, etc. An example computer system for executing the PCM techniques described herein is provided in FIG. 11, discussed below.

The PCM system may include an image collector engine that receives and stores the medical images and a registration engine that takes the images and performs a registration of serial IMAGES. The registration engine may provide a set of tissue specific parameters for tailoring the engine to register images of that tissue, where these parameters may represent physical characteristics of the tissue (e.g., general shape, position, expected volume, changes between physiological states or tissue densities, swelling due to edema, in the case of muscle tissue deformation due to contraction or atrophy and or changes in tissue due to tissue strain and elasticity tests to assess distensibility). The image registration can be achieved when necessary using algorithms to provide for higher degrees of freedom needed to align the images together. In examples where tissue shape changes occur between serial medical images, deformation may be performed as part of the registration, which may include scaling of at least one image data or portions thereof. In other embodiments, the registration may be a rigid registration without deformation. The registration process may be automatic in some embodiments, while in other embodiments there may be portions of the process that are performed manually.

After registration, a voxel analysis engine may examine the combined, registered image data from the registration engine, to perform a classification on the image data. The analysis engine, for example, may determine signal change across medical images on a voxel-by-voxel basis for the image data. The size of the region-of-interest (ROI) may be determined manually, e.g., by contouring over the analyzed tissue, or may be generated automatically by the medical imaging system, or some combination of automatic and manual determination of the ROI may be used. In addition to determining signal changes within each voxel, the analysis engine may also identify the relative volumes of the signal changes and the location of the changed and the unchanged voxels. While conventional ways of measuring registered data sets can be used, e.g., the mean of the Jacobian or dissimilarity measures based on the histograms of the images where information from the measure is pooled throughout the tissue into a single outcome measure, the measurements forfeit spatial information. Each individual voxel is a volume in 3D space that corresponds to a location in the tissue. Therefore, in some embodiments, the analysis engine retains the spatial information by classifying voxels into discrete groups that can be analyzed as a global metric but also allows the ability to identify local phenomena of the individual PCM metrics by generating overlays of the PCM metrics on the original anatomical image.

In analyzing the image data to identify signal changes, the analysis engine applies one or more thresholds, or cutoffs, to segment the data by tissue characteristics, in addition to retaining the spatial information. Any number of cutoffs can be used to analyze and highlight different tissue effects (for example, pathologies and/or physical states). The use of these thresholds is particularly distinct in that they are accompanied by the spatial details that are also provided with the PCM system.

In some embodiments, the voxel analysis engine is configured to perform tissue analysis on only a portion of the registered image data, for example, a particular tissue region or tissue sub-type. In such examples, the analysis engine may perform image segmentation to filter out image data not corresponding to the tissue region or sub-type of interest.

In some embodiments, PCM can be applied and analyzed over multiple imaging modalities acquired at multiple time points. In one embodiment, PCM can be applied separately on two modalities that are sensitive to different physiological properties of the tissue, for example. The individual PCM analyses on each modality can be combined into a single predictive metric. Another embodiment is to apply PCM on a voxel-basis over multiple modalities, phases and/or time points utilizing pre-determined thresholds to generate metrics that may be in the form of a relative volume within the tissue of interest. Another embodiment is to combine non-PCM based metrics—examples include but are not limited to metrics from bone mineral density (BMD), age, sex, fracture occurrence, etc., with PCM-based metrics into a single model-based outcome measure of clinical relevance. Examples of model generation include, but are not limited to, statistical, neural network, genetic programming, principal component analysis and independent component analysis based models for providing measures of clinical relevance.

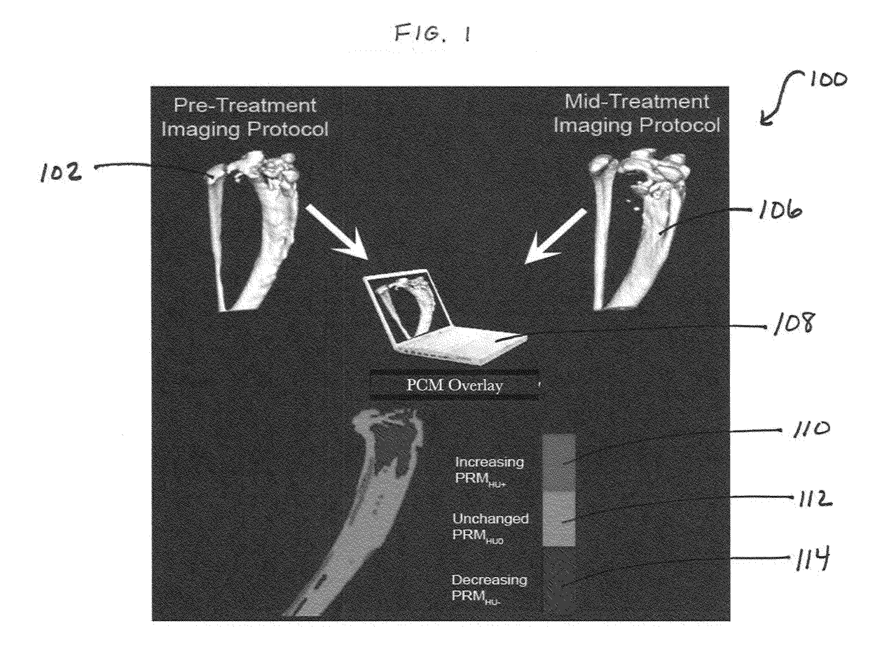

FIG. 1 illustrates an example implementation of the PCM technique 100 applied to CT image data scans of osseous tissue. As may be seen a first image of bone tissue 102 may be taken at a first time point, for example before treatment of the tissue, and a second image of bone tissue 106 may be taken at a second time point, for example at some point in the course of treatment of the bone. While this embodiment only describes the collection and use of two images, it will be understood that any number of images may be collected and used with embodiments of the present disclosure. Next, the two images may be processed 108, which may include registering the two images and creating a phenotype classification map. The PCM may be formed generally as follows. The serial Hounsfield unit (HU) value of each voxel within both images may be plotted as a function of the initial, for example, time of diagnosis, HU value. Voxels in which the HU value in the sequential scan has increased (red voxels) 110 and decreased (blue voxels) 114 significantly from baseline were segmented from the rest of the bone (green voxels) 112 to calculate the two PCM volumes: sum of red voxels (PCM(red)) and sum of blue voxels (PCM(blue)), respectively. As previously explained, while a particular color-coding scheme is described here, other color-coding schemes are possible, as are other coding schemes generally. Other cutoffs and thresholds can also be defined depending upon the tissue being analyzed and the purpose of the analysis. The threshold of a significant increase or decrease in voxel HU value can be determined. PCM according to the techniques of the present disclosure used for monitoring changes in bone density as a result of disease has been evaluated and verified in different diseases such as for example but not limited to osteoporosis and bone metastasis.

It will be understood that any reference to the use of specific products, including software, equipment, etc. throughout the description in the Examples is merely provided to accurately and fully describe how the study was conducted. However, such references are not in any way meant to limit embodiments of the present disclosure. Where a particular product is described as being used, it will be understood that any other suitable product may also be used with embodiments of the present disclosure.

### Example 1

The PCM technique of the present disclosure was used to identify local changes in bone density as a result of a metastatic cancer. According to some reports, bone metastases occur in approximately 70% of patients with metastatic breast cancer. The spine is involved in approximately 20% of patients who have only a solitary metastatic bone lesion and in approximately 50% of patients with multiple bone lesions. Without the use of osteoclast inhibition, the estimated yearly incidence of skeletal related events (SRE) is 3.5 with a median incidence of 1.3 for vertebral compression fractures. Use of bisphosphonates may decrease the risk of skeletal related events, including pathologic fractures, by approximately one third and the monoclonal antibody targeting RANKL, denosumab may further improve control of SREs by another 20%. SREs remain a clinically relevant problem.

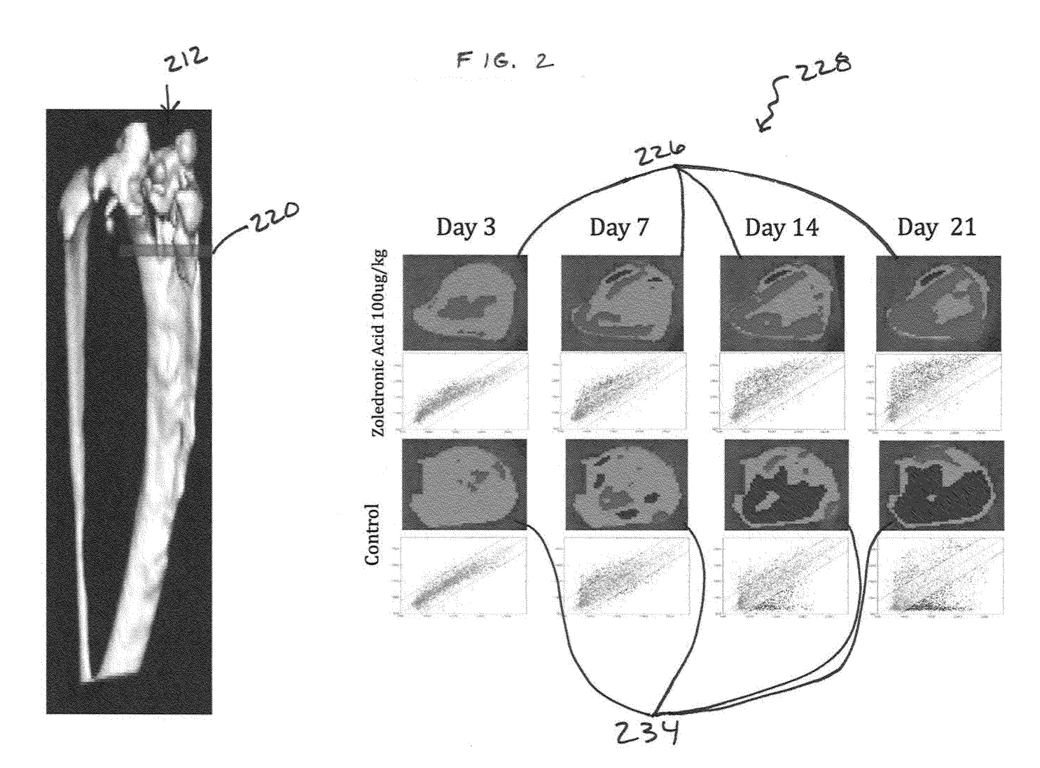

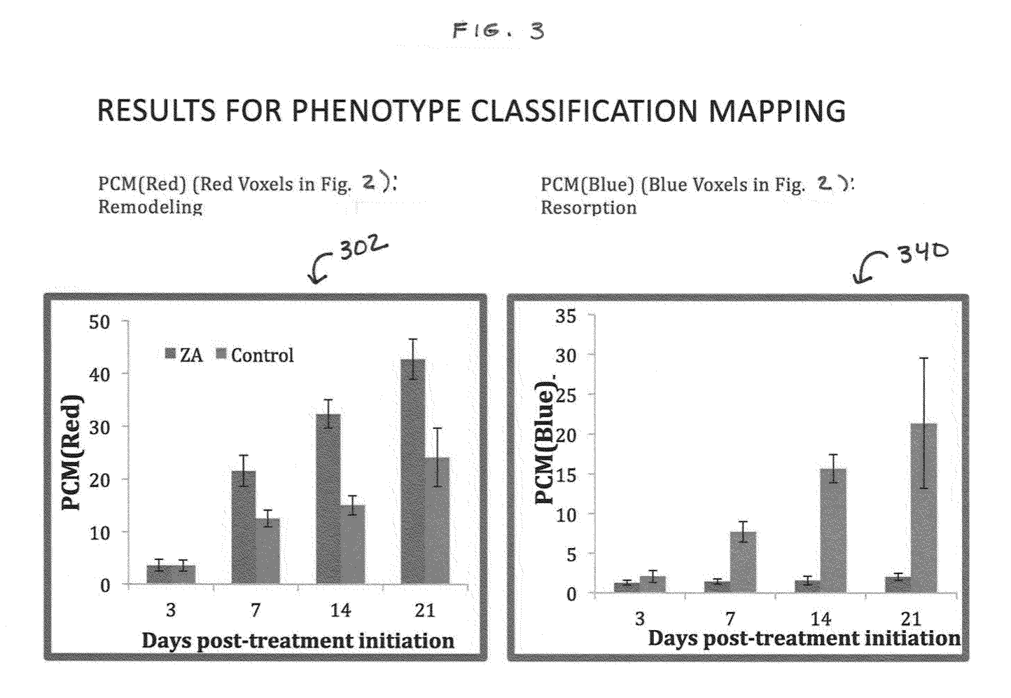

Mice with a site-specific tumor placed in the tibia were treated with either zoledronic acid (ZA) or vehicle. ZA is used to treat bone loss as a result of disease. Presented in FIG. 2 are representative PCM results of a single slice 220 through the tibia 212 of mice treated with ZA or vehicle. PCM results 228 clearly show that the bone density increases over time when treated with ZA 226 regardless of the presence of a cancer in the bone. Animals who received the vehicle 234 showed substantial loss in bone density around the site of metastases. Assessed over the entire groups as shown in FIG. 3 chart 302, animals treated with ZA produced significantly more regions of increasing bone density than controls (red voxels). In contrast, controls had significantly more bone loss as determined by PCM (blue voxels) than ZA treated animals as shown in chart 340. Overall, this data shows the ability of this approach for quantification and spatial visualization of changes over time due to the presence of a tumor and therapeutic intervention.

### Example 2

### Assessment of Osteoporosis by PCM

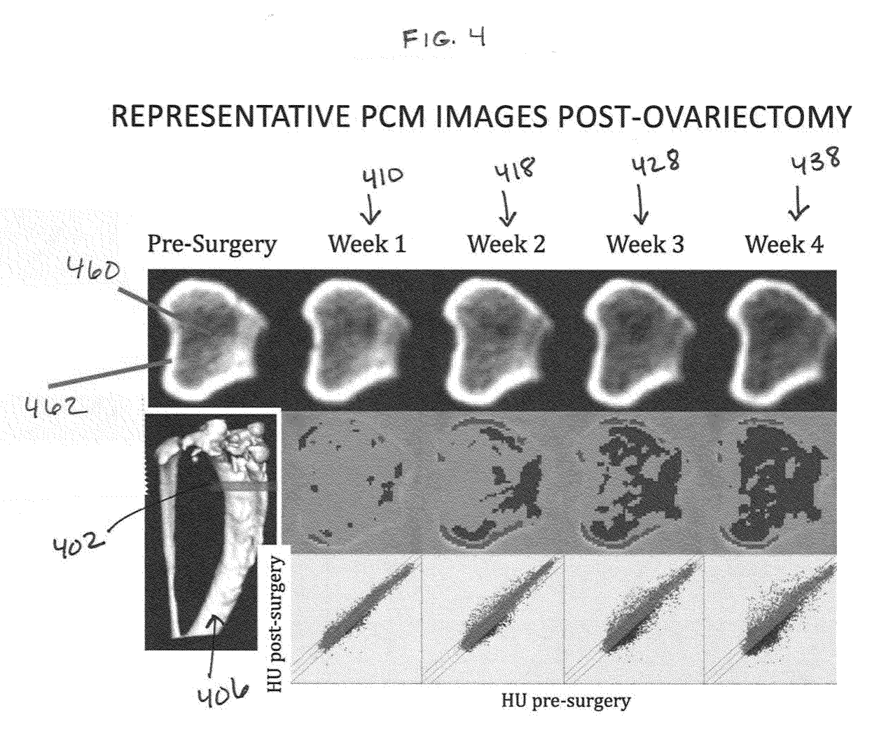

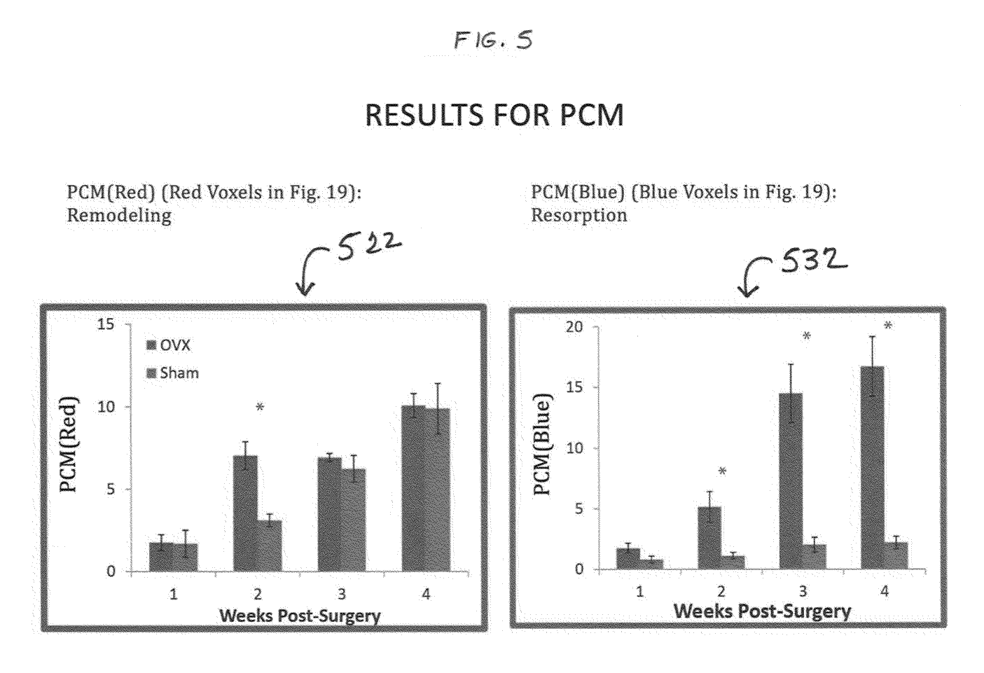

The PCM technique of the present disclosure may also be used to identify the local extent of osteoporosis in an animal model. Presented in FIG. 4 are representative images of a slice 402 though the tibia 406 from an ovariectomized animal. PCM overlays from CT scans acquired one 410, two 418, three 428 and four 438 weeks post-surgery clearly show local decrease in bone density (PCM(blue): blue voxels) which is associated with the progression of osteoporosis over time. The images show the state of the trabelcular bone 460 and the state of the cortical bone 462. As may be seen in FIG. 5, although animals who underwent surgery showed similar bone remodeling (PCM(red): red voxels) as sham animals as shown in chart 522, loss of bone density as determined by PCM was more substantial in ovariectomized animals than sham animals as shown in chart 532.

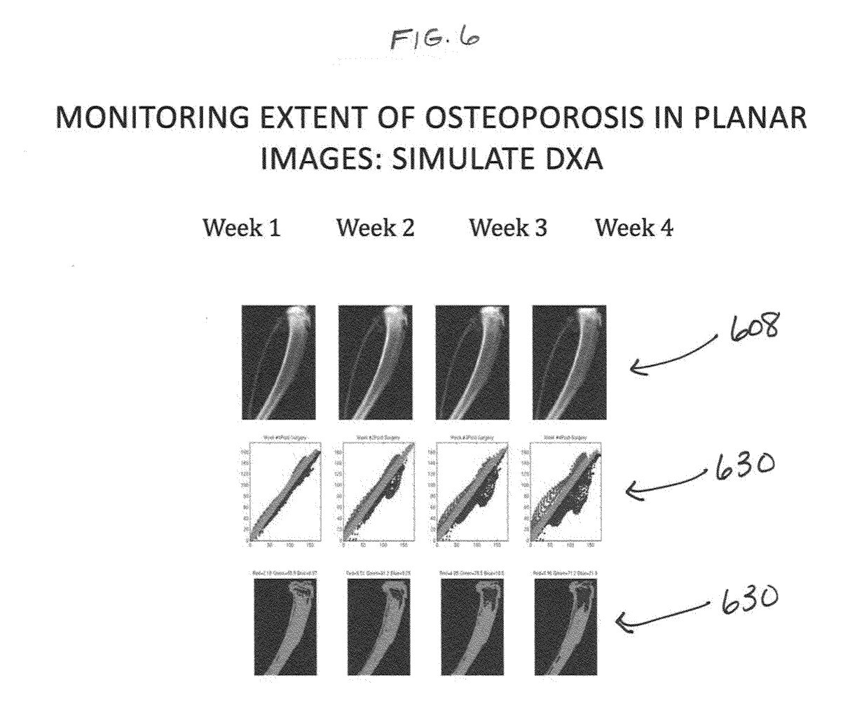

Clinical assessment of osteoporosis is typically determined using dual-energy x-ray absorptiometry (DEXA). This imaging modality acquires planar quantitative bone mineral density maps which clinicians use to determine bone integrity. The PCM methodology for analyzing 3-dimensional CT bone scans was applied to 2-dimensional planar X-Ray bone scans to show feasibility for application in planar image data. In this example, the 3D images were converted to 2D images to demonstrate the utility of PCM on planar images. As may be seen in FIG. 6, similar to the 3D data set 608, regions of bone loss are clearly identified by PCM in the 2D images 630 as blue pixels.

### Example 3

In another example, twelve female Sprague Dawley rats, 16 weeks old, were obtained from Charles River Labs and housed randomly in cages (2 per cage), fed with standard rat chow and tap water. The rats were divided into ovariectomized (OVX, n=8) and sham-operated control (n=4) groups. When the rats were 17 weeks old, bilateral ovariectomy operation from a dorsal approach was performed on the OVX group, while surgery with no ovary removal was performed on the Sham animals. The animal experiments described in this study complied with relevant federal and institutional policies.

In vivo imaging was performed on a Siemens Inveon system with the following acquisition parameters: 80 kVp, 500 pA, 300 ms exposure time, 501 projections over 360 degrees, 49.2 mm field of view (FOV, 96.1 pm pixel resolution). Imaging was performed on the day before surgery and days 6, 13, 20, and 27 post-surgery, capturing both tibiae of each rat as well as the distal femora. Right tibiae and femora were excised on day 28 post-surgery and stored in PBS-soaked gauze at −20° C. until ex vivo μCT imaging was performed.

Ex vivo μCT imaging was performed on a General Electric eXplore Locus SP system with the following parameters: 80 kVp, 80 p.A, 1600 ms exposure time, 400 projections, 0.5 degrees per projection, 4 frames averaged per projection, 18 pm reconstructed voxel size. For imaging, the sample was submerged in water, and X-rays were pre-filtered using 0.02″ aluminum. Each image captured the proximal tibia, from the tibial head to about 20 mm distally.

PCM analysis was performed using computer algorithms. In vivo CT images were converted to Hounsfield units using a 0 HU phantom on each time point. All post-OVX image time points were registered to baseline images using mutual information as an objective function and simplex as an optimizer. Registration was automatic and assumed rigid-body geometry, meaning rotation and translation only. Bone volumes of interest (VOI) were contoured on the baseline image using an automatic segmentation algorithm, selecting the tibia from the tibia/fibula junction to the proximal tibial head. Images were analyzed for bone volume fraction relative to total bone volume (BV/TV) and bone mineral density using a threshold of 600 HU for selecting mineralized bone tissue. Parametric response maps of quantitative CT as expressed in Hounsfield units (PCM_{HU}) were generated over the same region by first calculating the difference between the Hounsfield units (ΔHU=HUpost-Sx−HUpre-Sx) for each voxel within the bone pre- and post-surgery. Voxels yielding a ΔHU greater than a pre-determined threshold are designated red, decreased by more than the threshold are designated blue, and are otherwise designated green (indicating no significant change from pre-surgery). Volume fractions of the total bone are calculated for PCM_{HU+}, (increased HU), PCM_{HU-} (decreased HU), and PCM_{HU0} (unchanged HU). The threshold that designates a significant change in HU within a voxel was empirically calculated from one random subject imaged twice on the same day, separated by an interval of one hour. Following registration and conversion to HU of the two images, a linear least squares analysis was performed and the 95% confidence interval was determined for use as the PCM threshold, which was set as ±391 HU.

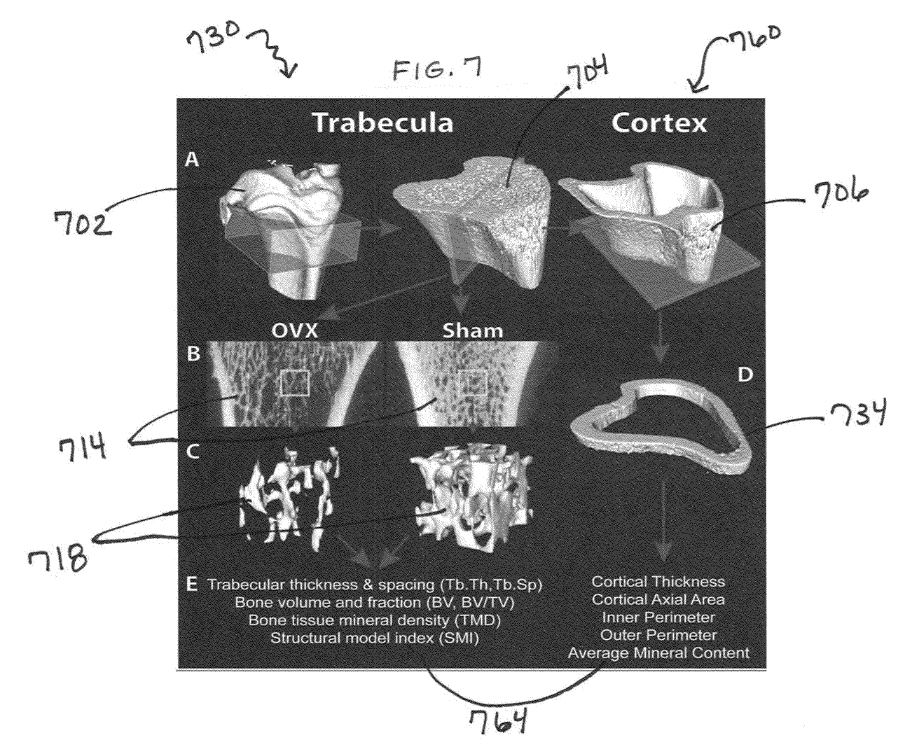

Trabecular VOI were drawn by hand and extrapolated between slices over a 3 mm-long region near the proximal tibia, as shown in FIG. 7. Measures of mean trabecular thickness (Tb.Th), trabecular spacing (Tb.Sp), total bone volume (BV), bone volume fraction (BV/TV), mean bone mineral density (BMD), and structure model index (SMI) 730 were analyzed. Cortical bone VOI were automatically delineated over the bottom four slices from the trabecular VOI. Measures of mean cortical thickness, cross-sectional area, and inner and outer perimeters were analyzed 760.

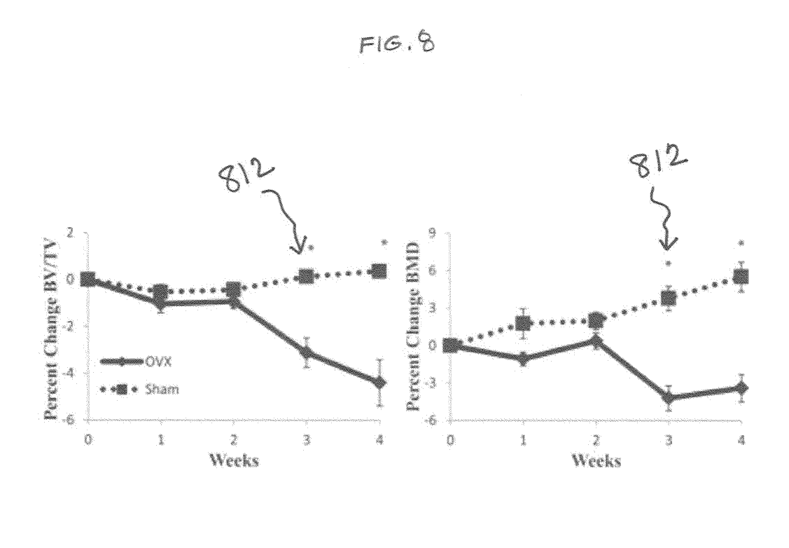

Significance between groups at each time point was determined by a two-tailed, unpaired student's t-test with p<0.05. Comparison of PCM_{HU} and standard whole-bone analyses were as follows. To compare the PCM method to conventional analysis, we analyzed weekly μCT images for BV/TV and BMD, and compared between groups. Analysis was constrained to tibial bone from proximal tibial plateau distally to tibia/fibula junction segmented on the baseline image. The results in FIG. 8 show significant differences between groups in both BV/TV and BMD starting at week three 812. In the OVX group, BV/TV decreased by 3.1±0.6% at the end of the study. BMD decreased by 4.2±1.0% on week 3 but saw no further change the following week (week 4).

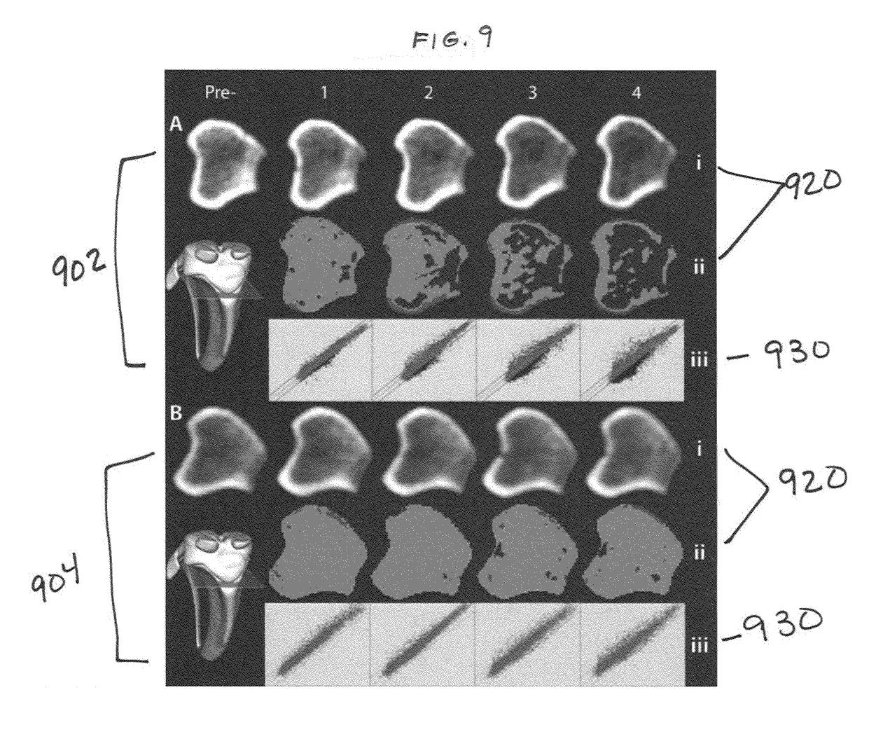

PCM results revealed trabecular bone loss as well as cortical expansion in the OVX group. FIG. 9 shows PCM analysis with a representative axial slice through the CT image (i-ii) 920 and the scatter plot for the entire VOI (iii) 930 over the study time period for both the OVX animal 902 and the sham animal 904. The representative slice shown near the proximal tibial plateau was chosen to include changes in both trabecular and cortical bone. Trabecular degradation is apparent in the OVX animal 902, PCM_{HU}, seen as blue in the PCM overlay and scatterplot. Also in the OVX group, PCM_{HU}+ (red voxels) indicates a shift in the cortical bone outward, reflecting cortical expansion. These two changes in bone structure are typical of this osteoporosis model. In contrast to the OVX animal, the sham animal 904 had very little change in PCM metrics. The few red and blue pixels observed were the result of natural bone growth and reflected modeling changes associated with skeletal growth.

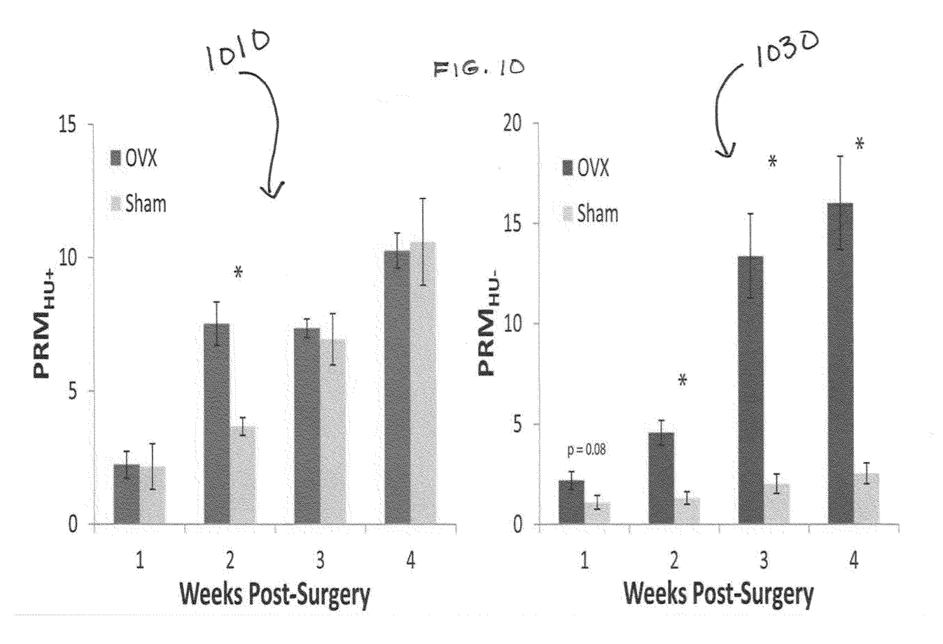

The volume fractions, PCM_{HU+} and PCM_{HU-}, were monitored over the study time period, as shown in FIG. 10, 1010, 1030. The PCM_{HU+} results 1010 showed a temporary increase on week 2 over control values. This significant difference was lost after week two indicating a transient remodeling effect on OVX animals. The PCM map shows that the majority of PCM_{HU+} is along the bone's outer edge, indicating that this increase is due mainly to cortical expansion. The subsequent loss of significance between groups is likely normal bone growth in the sham group catching up with the remodeling effect in the OVX group. The PCM_{HU-} results plot 1030 reflects progressive bone loss which is characteristic of this animal model, with significantly higher PCM_{HU-} values observed in OVX than sham animals at all time-points after week one post-surgery. As shown in FIG. 9, PCM_{HU-} voxels are primarily found in the cancellous bone space and indicate loss in trabecular bone mass. The increase is nearly significant even at the week one imaging time point (p=0.083). By the end of the study, at four weeks post-surgery, OVX and sham groups resulted in bone loss as measured by PCM_{HU-} of 16.0% (+/−2.3) and 2.5% (+/−0.8), respectively (p<0.001).

Ex vivo μCT measurements of tibial trabecular and cortical bone were as follows. To validate our in vivo results, we performed ex vivo μCT after four weeks on all animals in the study. Images were acquired with 18 μm resolution allowing quantification of trabecular structures. FIG. 7 illustrates the process of analysis for both trabecula and cortex, with resulting measurements. The location of the trabecular analysis slab (left) 702, region for maximum intensity projection (MIP) in B (middle) 704, and slab for cortical analysis (right) 706 is provided. FIG. 7 also shows representative MIP images 714 for OVX and sham animals, with a clearly lower trabecular bone mass in the OVX animal. Also show is the representative isosurfaces for the two groups 718, taken from the yellow region indicated in 714. FIG. 7 further shows an isosurface 734 of the cortical bone from a representative animal, which was used for cortical analysis. Resulting measurements 764 are also provided, and group means are shown in Tables 1 and 2 (provided below) for trabecular bone and cortical bone, respectively. Significant differences were seen between groups in all trabecular measurements, indicating degradation of trabecular structure. Structural model index (SMI) measurements quantify the extent of rod- or disc-like shaping of the trabecular lattice, with higher values indicating more rod-like and lower indicating more disc-like shaping. Cortical measurements of average thickness, inner, and outer perimeters also showed significant differences between groups. Larger perimeters and decreased cortical thickness in the OVX group indicate significant cortical expansion, which is consistent with this model. No significant change in cross-sectional area indicates that remodeling occurred without significant loss of total bone, which corroborates our in vivo volume measurement results.

TABLE 1

| | Tb. Th | Tb. Sp | BV | | BMD | |
|---|---|---|---|---|---|---|
| Group | (μm) | (μm) | (mm³) | BV/TV | (mg/mm³) | SMI |
| OVX | 50.8 | 173 | 8.6 | 0.29 | 363 | 1.57 |
| | (1.94) | (16.5) | (0.62) | (0.021) | (16.7) | (0.14) |
| Sham | 73 | 65.3 | 14.2 | 0.6 | 564 | −2.16 |
| | (4.03) | (10.87) | (0.88) | (0.045) | (25) | (0.858) |
| p-value | 0.0058 | 0.0003 | 0.0019 | 0.0026 | 0.0007 | 0.021 |

The data in Table 6 are shown as means, with standard error in parentheses, for trabecular thickness and spacing (Tb. Th and Tb. Sp, respectively), bone volume (BV), bone volume ratio (BV/TV), bone mineral density (BMD), and structural model index (SMI).

TABLE 2

| | | | | Inner | Outer |
|---|---|---|---|---|---|
| | Thickness | Area | Mineral | Perimeter | Perimeter |
| Group | (mm) | (mm²) | (mg) | (mm) | (mm) |
| OVX | 0.45 | 4.51 | 0.1 | 11.1 | 17.2 |
| | (0.014) | (0.164) | (0.002) | (0.28) | (0.2) |
| Sham | 0.53 | 4.86 | 0.102 | 9.7 | 15.3 |
| | (0.013) | (0.067) | (0.0026) | (0.34) | (0.51) |
| p- | 0.0023 | 0.0815 | 0.5329 | 0.0166 | 0.0278 |
| value | | | | | |

The data in Table 7 are shown as means, with standard error in parentheses.

The examination evaluated PCM analysis on bone mineral changes using in vivo μCT. Toward this end, we used a well-documented model of osteoporosis in rats, where removal of the ovaries initiates bone degradation due to hormone deprivation. This animal model has been shown to result in highly-reproducible bone loss, characterized by site-dependent decreases in overall bone mass as well as diminished trabecular structure and cortical expansion. Clinical osteoporosis is characterized by decreases in either bone mineral density (BMD) or bone mineral content (BMC) of over 2.5 standard deviations below the young adult reference mean (−2.5 T-score), which lead to increased fragility and consequently a greater risk of SREs. It is reported that the earliest time of statistically detectable cancellous bone loss is approximately 14 days post-OVX in this animal model. In this study, PCM showed a near-significant change in PCM_{HU-} by one week post-surgery, which became significant 2 weeks post-OVX, well before any significant difference in BMD was detected. In addition to being an early biomarker of bone remodeling, PCM also provided locally-resolved information on bone degradation and growth.

Although this study used a model of osteoporosis, PCM analysis may prove useful in determining bone response to therapy. Bisphosphonates, used clinically for several years, inhibit the resorption of bone by osteoclasts. Interestingly, the degree of fracture risk reduction following bisphosphonate therapy is not well explained by changes in bone mass alone. Following one year of Risedronate therapy in 2087 individuals, Watts et al. (Watts NB, Geusens P, Barton IP, Felsenberg “Relationship Between Changes in BMD and Nonvertebral Fracture Incidence Associated with Risedronate: Reduction in risk of Nonvertebral Fracture is not Related to Change in BMD,” J Bone Miner Res 2005; 20:2097-104) found that fracture risk reduction was not dependent on change in BMD, indicating that other factors such as remodeling of bone geometry, etc. must play significant roles. PCM analysis according to the present disclosure may provide a sensitive biomarker of bone response to these therapies, leading to prediction of overall outcome by direct observation of local sites of anabolic or anti-catabolic effect.

Another application of PCM is in the assessment of bone response to metastatic cancer. Breast and prostate primary cancers frequently metastasize to bone as they progress, and generally present as either osteolytic or osteoblastic lesions. Local changes in bone mass due to metastatic disease can significantly impact the mechanical integrity of the skeleton, leading to focal sites of high fracture susceptibility. PCM analysis may provide a unique and sensitive measure in differentiating the osteoblastic and osteolytic sites which would be highly valuable in strategizing corrective therapy based on local fragility. Recent studies have uncovered a close interaction between bone and cancer metastases through molecular signals and osteoclasts, coined the “vicious cycle,” in which growth of the cancer is highly dependent on degradation of the surrounding bone. PCM_{HU} analysis may be applied to metastatic cancer to bone in order to show initial formation of micro-metastases in the bone as well as the effect of treatments targeted at halting the “vicious cycle”. Due to the cancer/bone interaction, treatments are likely to affect both, adding to the complexity of the problem.

### Example PCM System

FIG. 11 is a block diagram of an example computer system 1000 on which a tissue phenotype classification system may operate, in accordance with the described embodiments. The computer system 1000 may be a PCM system, for example. The computer system 1000 includes a computing device in the form of a computer 1010 that may include, but is not limited to, a processing unit 1020, a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (Pa) bus (also known as Mezzanine bus).

Computer 1010 typically includes a variety of computer readable media. Computer readable media can be any available media that can be accessed by computer 1010 and includes both volatile and nonvolatile media, and both removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1010. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above are also included within the scope of computer readable media.

The system memory 1030 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within computer 1010, such as during start-up, is typically stored in ROM 1031. RAM 1032 typically contains data and/or program modules that are immediately accessible to and/or presently being operated on by processing unit 1020. By way of example, and not limitation, FIG. 26 illustrates operating system 1034, application programs 1035, other program modules 1036, and program data 1037.

The computer 1010 may also include other removable/non-removable, volatile/nonvolatile computer storage media. By way of example only, FIG. 11 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 11 provide storage of computer readable instructions, data structures, program modules and other data for the computer 810. In FIG. 11, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies. A user may enter commands and information into the computer 1010 through input devices such as a keyboard 1062 and cursor control device 1061, commonly referred to as a mouse, trackball or touch pad. A monitor 1091 or other type of display device is also connected to the system bus 1021 via an interface, such as a graphics controller 1090. In addition to the monitor, computers may also include other peripheral output devices such as printer 1096, which may be connected through an output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 11. The logical connections depicted in FIG. 11 include a local area network (LAN) 1071 and a wide area network (WAN) 1073, but may also include other networks. Such networking environments are commonplace in hospitals, offices, enterprise-wide computer networks, intranets and the Internet. In the illustrated example, the remote computer 1080 is a medical imaging device, such as a CT scanning device, PET scanning device, MRI device, SPECT device, etc. The remote computer 1080, therefore, may be used to collect various image data of a sample region of tissue at different phases of movement, as in the example of a COPD diagnosis, or at different times for a static tissue, such as a bone. The remote computer 1080, therefore, may collect image data containing a plurality of voxels each characterized by some signal value, for example, a value measured in Hounsfeld values.

While a single remote computer 1080 is shown, the LAN 1071 and/or WAN 1073 may be connected to any number of remote computers. The remote computers may be independently functioning, for example, where the computer 1010 serves as a master and a plurality of different slave computers (e.g., each functioning as a different medical imaging device), are coupled thereto. In such centralized environments, the computer 1010 may provide one or both of an image processing module and a tissue pathology diagnostic (as used herein “pathology diagnostic” includes tissue phenotype classification for any purpose including diagnosis, prognosis, treatment assessment, etc.) module for a group of remote processors, where the image processing module may include an image collector engine and a deformation registration engine and the pathology diagnostic module may include a voxel analysis engine. In other examples, the computer 1010 and a plurality of remote computers operate in a distributed processing manner, where imaging processing module and pathology diagnostic module are performed in a distributed manner across different computers. In some embodiments, the remote computers 1080 and the computer 1010 may be part of a “cloud” computing environment, over the WAN 1073, for example, in which image processing and pathology diagnostic services are the result of shared resources, software, and information collected from and push to each of the computers. In this way, the remote computers 1080 and the computer 1010 may operate as terminals to access and display data, including pathology diagnostics (tissue phenotype classification), delivered to the computers through the networking infrastructure and more specifically shared network resources forming the “cloud.”

It is noted that one or more of the remote computers 1080 may function as a remote database or data center sharing data to and from the computer 1010.

When used in a LAN networking environment, the computer 1010 is connected to the LAN 1071 through a network interface or adapter 1-70. When used in a WAN networking environment, the computer 1010 typically includes a modem 1072 or other means for establishing communications over the WAN 1073, such as the Internet. The modem 1072, which may be internal or external, may be connected to the system bus 1021 via the input interface 1060, or other appropriate mechanism. In a networked environment, program modules depicted relative to the computer 1010, or portions thereof, may be stored in the remote memory storage device 1081. By way of example, and not limitation, FIG. 11 illustrates remote application programs 1085 as residing on memory device 1081. The communications connections 1070, 1072 allow the device to communicate with other devices. The communications connections 1070, 1072 are an example of communication media.

The methods for analyzing a sample region of a body to determine the state or condition of a tissue region of interest as described above may be implemented in part or in their entirety using one or more computer systems such as the computer system 1000 illustrated in FIG. 11.

Some or all calculations performed in the pathology condition determination may be performed by a computer such as the computer 1010, and more specifically may be performed by a processor such as the processing unit 1020, for example. In some embodiments, some calculations may be performed by a first computer such as the computer 1010 while other calculations may be performed by one or more other computers such as the remote computer 1080, as noted above. The calculations may be performed according to instructions that are part of a program such as the application programs 1035, the application programs 1045 and/or the remote application programs 1085, for example. Such functions including, (i) collecting image data from a medical imaging device, either connected remotely to the device or formed as part of the computer system 100; (ii) rigid-body and/or deformably registering, in an image processing module, such collected image data to produce a co-registered image data comprising a plurality of voxels; (iii) determining, in the image processing module, changes in signal values for each of the plurality of voxels for the co-registered image data between a first phase state and the second phase state; (iv) forming, in a pathology diagnostic module, a tissue classification mapping data of the changes in signal values from the co-registered image data, wherein the mapping data includes the changes in signal values segmented by the first phase state and the second phase state; (v) performing, in the pathology diagnostic module, a threshold analysis of the mapping data to segment the mapping data into at least one region indicating the presence of the pathology condition and at least one region indicating the non-presence of the pathology condition; and (vi) analyzing the threshold analysis of the mapping data to determine the presence of the pathology condition in the sample region.

Relevant data may be stored in the ROM memory 1031 and/or the RAM memory 1032, for example. In some embodiments, such data is sent over a network such as the local area network 1071 or the wide area network 1073 to another computer, such as the remote computer 1081. In some embodiments, the data is sent over a video interface such as the video interface 1090 to display information relating to the pathology condition to an output device such as, the monitor 1091 or the printer 1096, for example. In other examples, the data is stored on a disc or disk drive, such as 856 or 852, respectively.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments for purposes of illustration only. One skilled in the art will readily recognize from the discussion herein that alternative embodiments of the structures and methods illustrated herein may be employed without departing from the principles described herein.

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method of analyzing a sample region of a body to determine the state of the tissue, the method comprising:
collecting, using a medical imaging device, a first image data set of the sample region at a first time point, the first image data set comprising a first plurality of voxels each characterized by a signal value in the first image data;
collecting, using the medical imaging device, a second image data set of the sample region while at a second time point, the second image data set comprising a second plurality of voxels each characterized by a signal value in the second image data;
registering, in an image processing module, the first image data set to produce a spatially transformed third image data set comprising a plurality of voxels, such that the third image data set includes the first image data set and the second image data set registered to share the same geometric space, and wherein each of the plurality of voxels comprising the third data set includes information derived from corresponding voxels in both the first and second image data set;
determining, in the image processing module, changes in signal values for each of the plurality of voxels in the third image data set, wherein the change is the change in signal values between corresponding voxels in both the first and second image data set, which are both included in the third image data set;
forming, in a pathology diagnostic module, a tissue classification map of mapping data including changes in signal values from the registered image data, wherein the mapping data includes the changes in signal values segmented by the first time point and the second time point; and
performing, in the pathology diagnostic module, a threshold analysis of the mapping data to segment the mapping data into a plurality of regions, including at least one region indicating the presence of a first tissue state condition and at least one region indicating the non-presence of the first tissue state condition.

2. The method of claim 1, wherein performing the threshold analysis of the mapping data includes providing a cutoff value to segment the mapping data into the plurality of regions.

3. The method of claim 1, wherein the sample region of the body is bone tissue.

4. The method of claim 3, wherein the cutoff value to segment the mapping data into the plurality of regions is selected to indicate bone mineralization occurring between the first time point and the second time point.

5. The method of claim 4, wherein the analysis is performed to determine the extent of osteoporosis.

6. The method of claim 4, wherein registering the first image and the second image comprises applying a rotation and translation rigid body registration of the first image and the second image.

7. The method of claim 6, wherein determining changes in signal values for each of the plurality of voxels in the third image data set between the first time point and the second time point comprises determining increases in signal values and decreases in signal values.

8. The method of claim 7, wherein the medical imaging device is a computed tomography device, and wherein changes in signal values are measured in Hounsfield units.

9. The method of claim 1, wherein the medical imaging device is selected from the group consisting of a magnetic resonance imaging (MRI) device, a computed tomography (CT) device, a two-dimensional planar X-Ray device, a positron emission tomography (PET) device, an ultrasound (US) device, a dual-energy X-Ray absorptiometry (DEXA), and a single-photon emission computed tomography (SPECT) device.

10. A method of analyzing a sample region of bone tissue to assess bone integrity, the method comprising:
collecting, using a medical imaging device, a first image data of the sample region at a first time point, the first image data comprising a first plurality of voxels each characterized by a signal value in the first image data;
collecting, using the medical imaging device, a second image data of the sample region at a second time point, the second image data comprising a second plurality of voxels each characterized by a signal value in the second image data;
performing registration, in an image processing module, on the first image data and the second image data to produce a co-registered image data comprising a third plurality of voxels each corresponding to at least one of the first plurality of voxels and at least one of the second plurality of voxels;
determining changes in signal values for each of the third plurality of voxels for the co-registered image data between the first time point and the second time point;
forming bone integrity classification mapping data of the changes in signal values from the co-registered image data, wherein the mapping data includes the changes in signal values segmented by the first time point and the second time point; and
performing a threshold analysis of the mapping data to segment the mapping data into at least one region indicating the presence of mineralized bone tissue, and at least one region indicating the reduction of mineralized bone tissue.

11. The method of claim 10, wherein at least one of the first and second image data sets comprise 2D images.

12. The method of claim 10, wherein at least one of the first and second image data sets comprise 3D images.

13. The method of claim 10, wherein the first image data set is collected from a different medical imaging device than the second image data set.

14. The method of claim 10, wherein the medical imaging device is a computed tomography device, and wherein changes in signal values are measured in Hounsfield units.

15. The method of claim 14, wherein performing the threshold analysis of the mapping data comprises identifying one or more signal cutoff values to segment the mapping data into the at least one region indicating the presence of mineralized bone tissue and the at least one region indicating the non-presence of mineralized bone tissue.

16. The method of claim 15, wherein at least one signal cutoff value is 600 HU.

17. The method of claim 16, wherein the bone tissue is treated between the first time point and the second time point.

18. An apparatus having a processor and a computer-readable medium that includes instructions that when executed by the processor cause the apparatus to:
collect, from a medical imaging device, a first image data of a sample region of bone tissue at a first time point, the first image data comprising a first plurality of voxels each characterized by a signal value in the first image data;
collect, from the medical imaging device, a second image data of the sample region of bone tissue at a second time point, the second image data comprising a second plurality of voxels each characterized by a signal value in the second image data;
perform rigid registration of the first and second image data, in an image processing module of the apparatus, to produce a co-registered image data comprising a third plurality of voxels each corresponding to at least one of the first plurality of voxels and at least one of the second plurality of voxels;
determine, in the image processing module, changes in signal values for each of the third plurality of voxels for the co-registered image data between the first time point and the second time point;
form, in a pathology diagnostic module of the apparatus, tissue state classification mapping data of the changes in signal values from the co-registered image data, wherein the mapping data includes the changes in signal values segmented by the first time point and the second time point; and
perform, in the pathology diagnostic module, a threshold analysis of the mapping data to segment the mapping data into a plurality of regions, including at least one region indicating the presence of a first tissue condition and at least one region indicating the non-presence of the first tissue condition.

19. The apparatus of claim 18, wherein the apparatus is used to determine the change in bone density occurring between time point one and time point two, where the change is associated with metastatic cancer.

20. The apparatus of claim 18, wherein the apparatus is used to determine the change in bone density occurring between time point one and time point two, where the change is associated with primary cancer.

21. The apparatus of claim 18, wherein the apparatus is used to determine the change in bone density occurring between time point one and time point two, where the change is associated with osteoporosis.

22. The apparatus of claim 18, wherein the apparatus is used to determine the change in bone density occurring between time point one and time point two, where the change is associated with an osteolytic or osteoblastic bone lesion or with a bone lesion consisting of both lytic and blastic components simultaneously.

23. The apparatus of claim 18, wherein the apparatus is used to determine the change in bone density occurring between time point one and time point two, where the change is associated with therapeutic interventions including bone-building drugs.
